(19) United States
(12) Patent Application Publication
(10) Pub. No.: US 2011/0024416 A1
(43) Pub. Date: Feb. 3, 2011

(54) GASKETLESS LOW TEMPERATURE HERMETIC SEALING WITH SOLDER

(75) Inventors: Yuwei Xun, Cockeysville, MD (US); David Van Heerden, Baltimore, MD (US); Maureen A. Curran, Queenstown, MD (US); Timothy P. Weihs, Baltimore, MD (US)

Correspondence Address: Polster, Lieder, Woodruff & Lucchesi, L.C., 12412 Powerscourt Dr. Suite 200, St. Louis, MO, 63131-3615, US

(73) Assignee: REACTIVE NANOTECHNOLGIES, INC., Hunt Valley, MD (US)

(21) Appl. No.: 12/666,000

(22) PCT Filed: Jun. 26, 2008
(86) PCT No.: PCT/US08/68410

§ 371 Date: Oct. 15, 2010

Related U.S. Application Data
(63) Continuation of application No. 60/946,309, filed on Jun. 26, 2007.

(51) Int. Cl. B65D 55/00; B23K 31/02; B23K 35/14; B32B 15/04

(52) U.S. Cl. 220/200; 228/234.3; 228/56.3; 428/457

(57) ABSTRACT

In accordance with the invention, containers or interfaces having two surfaces 201a and 201b to be joined, and a region to be sealed, are fused by providing between the surfaces 201a and 201b a thin strip or wire of RCM 102 embedded within a fusible material 101, applying pressure 205 and igniting the RCM 102. The released energy from the ignited RCM 102 results in a melting of the fusible material 101 and subsequent bonding of the fusible material 101 upon cooling to the 101 surrounding surfaces 201a and 201b, achieving a hermetic seal there between without the use of a separate gasket component.

### RELATED APPLICATIONS

This application claims the benefit of U.S. Provisional Application Ser. No. 60/946,309 filed on Jun. 26, 2007 and herein incorporated by reference.

### STATEMENT REGARDING FEDERALLY SPONSORED RESEARCH

The United States government has certain rights in this invention pursuant to NSF Award No. 0637902.

### BACKGROUND ART

This invention is related generally to the sealing of containers or interfaces, and in particular to a seal assembly and method for forming hermetic seals using solder by heating only the sealing surfaces.

Many microelectronic devices such as photocells, capacitors, sensors, MEMS, aerospace electronics, and medical instruments require protection from air and moisture to prevent corrosion and degradation. These sensitive components are typically placed in a package and sealed by attaching a lid to the package. Such a seal is called a hermetic seal if the helium leak rate across the seal is less than 10⁻⁸ atm·cc/s.

Several simple methods exist for sealing sensitive devices and components, including adhesives and epoxies and mechanical fasteners. However, adhesives and epoxies suffer from potential degradation due to exposure to heat and humidity and give off vapors (out-gas) during service. Adhesive seals are generally considered to be only near-hermetic. Mechanical fasteners require tight machining tolerances and suffer from potentially low reliability. In addition, mechanical fasteners are bulky and limited to relatively large sizes. For high-end applications, a preferred method is laser welding. When carefully applied, this method results in strong, uniform bonds and is consequently quite effective at limiting leak rates to very small values. This method, however, is very expensive and requires excellent surface finish and matching between the lid and enclosure. Additional drawbacks include possible thermal damage to the materials being joined, which in extreme cases results in loss of both the enclosure and the components. Other sealing technologies, namely resistance welding and reflow soldering, also have severe limitations. The major drawback of resistance welding is that the voltages required to create the seal are inappropriate for sensitive packages. Reflow soldering exposes components to unacceptably high temperatures. Thus, there is need for improved, more effective means for hermetically sealing sensitive components and devices.

Reactive multilayer joining is a relatively new joining technique that is based on sandwiching a reactive composite material (RCM) such as a reactive multilayer foil between two layers of a fusible material and the two components to be joined, and then igniting the foil. A self-propagating reaction is thus initiated in the reactive multilayer foil which results in a rapid rise in the reactive multilayer foil temperature. The heat released by the reaction melts the fusible-material layers, and upon cooling, bonds the two components. This method of joining is described in U.S. Pat. No. 6,534,194 and in US Patent Applications Publication Nos. 2004-0247931 A1, 2005-0082343 A1, and 2005-0136270 A1 each of which are incorporated herein by reference. The making of reactive composite materials (RCM's) is described in detail in U.S. Pat. Nos. 6,736,942 and 6,534,194 both of which are incorporated herein by reference, as well as U.S. Patent Application Publication No. 2008-0093418 A1, herein incorporated by reference.

Reactive multilayer joining has been previously used for sealing a deformable gasket or member separate from the solder and RCM preform, as described in U.S. Pat. Nos. 7,121,402 and 7,143,568, incorporated herein by reference. The gasket or separate member is an extra component, requiring adaptation of the sealing surfaces and alignment.

Accordingly, it would be advantageous to provide a method for forming a seal or sealing a container utilizing a reactive composite material, such as a reactive multilayer foil, to heat the sealing surfaces and which does not require a separate gasket component.

### SUMMARY OF THE INVENTION

A method of the present invention provides a sealing process for containers or interfaces having two surfaces to be joined and a region to be sealed. Initially, a thin strip or wire of reactive composite material surrounded with a fusible material is disposed between the surfaces to be sealed, extending at least peripherally around the region to be sealed. A pressure is applied to the reactive composite material within the fusible material, and the reactive composite material ignited. The heat generated by the ignition of the reactive composite material fuses the fusible material to the adjacent surfaces, which then cools to form a hermetic seal without the use of a separate gasket component.

### BRIEF DESCRIPTION OF THE DRAWINGS

FIG. 1 is a schematic representation of reactive multilayer joining;

FIG. 2 is a side view of a seal formed by the process of FIG. 1 wherein cracks in the RCM may be filled or unfilled;

FIG. 3 is a plan view of the seal of FIG. 2;

FIG. 4A illustrates the RCM and sheet solder arrangement for assembly in a sealing preform;

FIG. 4B shows the components of FIG. 4A assembled to form the sealing preform;

FIGS. 5A and 5B illustrate the formation of a sealing preform;

FIG. 6A shows two components and a sealing preform before reaction;

FIG. 6B shows the two components of FIG. 6A sealed with a sealing preform after reaction;

FIG. 7 illustrates exemplary cross-section profiles for an RCM;

FIG. 8 illustrates exemplary cross-section profiles of a sealing preform comprising an RCM with surrounding solder;

FIG. 9 illustrates a container and lid with a sealing preform that does not have an opening in it;

FIG. 10 illustrates a sealing preform with multiple loops of RCM;

FIG. 11 illustrates an alternate configuration for the sealing preform of FIG. 10;

FIG. 12 is a sectional view of a sealing preform in which the solder sheets have grooves to accommodate the RCM strips;

FIG. 13 is a sectional view of a sealing preform in which the RCM strips are interspersed with wires comprising solder or another material;

FIGS. 14A and 14B illustrate a semi-continuous sealing preform ribbon; and

FIG. 15 shows a sealing preform and sealing surface design adapted to prevent shear forces on the seal.

Corresponding reference numerals indicate corresponding parts throughout the several figures of the drawings. It is to be understood that the drawings are for illustrating the concepts set forth in the present disclosure and are not to scale. Before any embodiments of the invention are explained in detail, it is to be understood that the invention is not limited in its application to the details of construction and the arrangement of components set forth in the following description or illustrated in the drawings.

### BRIEF MODES FOR CARRYING OUT THE INVENTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

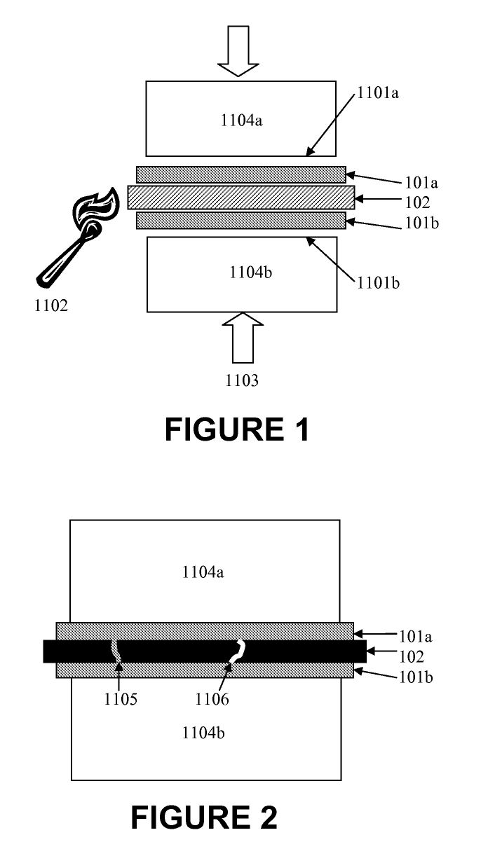

Reactive composite materials have been utilized previously to seal surfaces together in non-hermetic seals, without the use of a gasket, by employing techniques similar to those used to join bodies together in a non-sealing configuration, as described in U.S. Pat. No. 6,534,194 and in US Patent Applications Publication Nos. 2004-0247931 A1, 2005-0082343 A1, and 2005-0136270 A1. FIGS. 1 through 3 illustrate this prior art joining process schematically. These techniques utilize a sheet of RCM 102 which is as wide as, or slightly wider than, the solder sheets 101 and the sealing surfaces 1101 of the components 1104A and 1104B to be joined. The sheet 102 is placed between the sealing surfaces 1101A and 1101B of the components 1104, together with solder sheets 101a and 101b. Alternatively, the solder 101 may be applied directly to the sealing surfaces in a prior step. Pressure 1103 is then applied to hold the components 1104A and 1104B against the solder 101 and the RCM 102 while a momentary ignition source, represented by match 1102, is used to ignite the self-propagating reaction in the RCM 102 that generates sufficient heat to melt the solder layers 101. As the melted solder 101 cools, the solder adheres to the RCM 102 and to the sealing surfaces 1101, joining the components 1104.

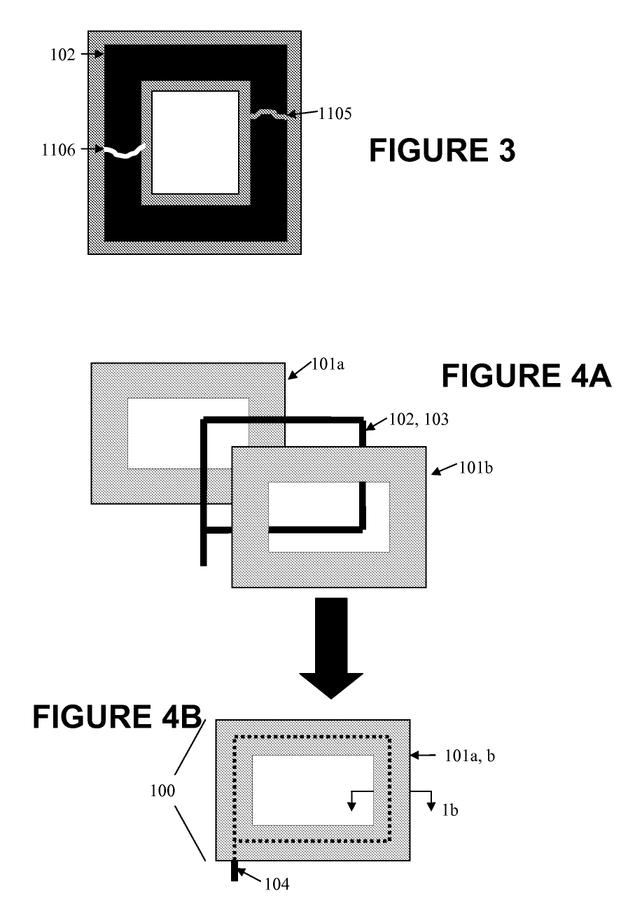

Joining without a gasket is a highly effective joining method, however, such joining does not form a hermetic seal. During the reaction, the RCM 102 changes phase from layers of elements to a monolithic intermetallic compound. This process results in a shrinkage of the RCM 102, leading to cracking, as shown in FIGS. 2 and 3. If the cracks form while the solder is molten, such as crack 1105, they usually fill with molten solder, creating in essence a composite material with brittle intermetallic islands in a metallic solder matrix. However, if the cracks form after the solder has solidified or nearly solidified, the cracks may not be filled, such as crack 1106. These unfilled cracks 1106 become leaks if the RCM 102 and solder 101 are expected to be a seal between the components 1104A and 1104B.

Turning to FIGS. 4A and 4B, a sealing method and assembly of the present disclosure is shown which avoids the presence of leaks in a resulting seal caused by the formation of cracks spanning the entire width of a sealing surface. The sealing method and assembly of the present disclosure ensures that solder 101 surrounds the RCM 102 entirely, ultimately sealing around any resulting cracks which form in the RCM 102 during the exothermic reaction. To this end, the RCM 102 does not extend to the boundaries of the joining surfaces, but is instead disposed as a narrow strip within the boundaries of the adjacent solder material 101. When the RCM strip reacts, it melts the solder around it, forming a seal without necessarily filling all of the cracks that might form in the RCM. Since the RCM 102 does not extend to the peripheral boundaries of the joining surfaces, any cracks formed therein similarly do not extend to the peripheral boundaries, and therefore do not result in leaks across the seal.

In one embodiment, shown in FIG. 4A, a flat strip of RCM 102 is folded to form a gasket shape 103, conforming to the shape of the sealing surfaces, e.g. a rectangle if the container opening is rectangular. The folded RCM strip 103 is then sandwiched between two sheets of solder 101 as shown in FIG. 4B. Advantageously, the solder sheets are cut to the shape of the sealing surfaces, forming “window frames” which are wider than the strip of RCM 102. The solder 101 and strip 102 assembly is pressed to cause the solder sheets 101a and 101b to adhere to the strip of RCM 102, forming a seal preform 100. Advantageously, one end 104 of the RCM strip 102 is left to extend beyond the peripheral boundary of the solder 101 to provide an easy ignition point for igniting the RCM 102.

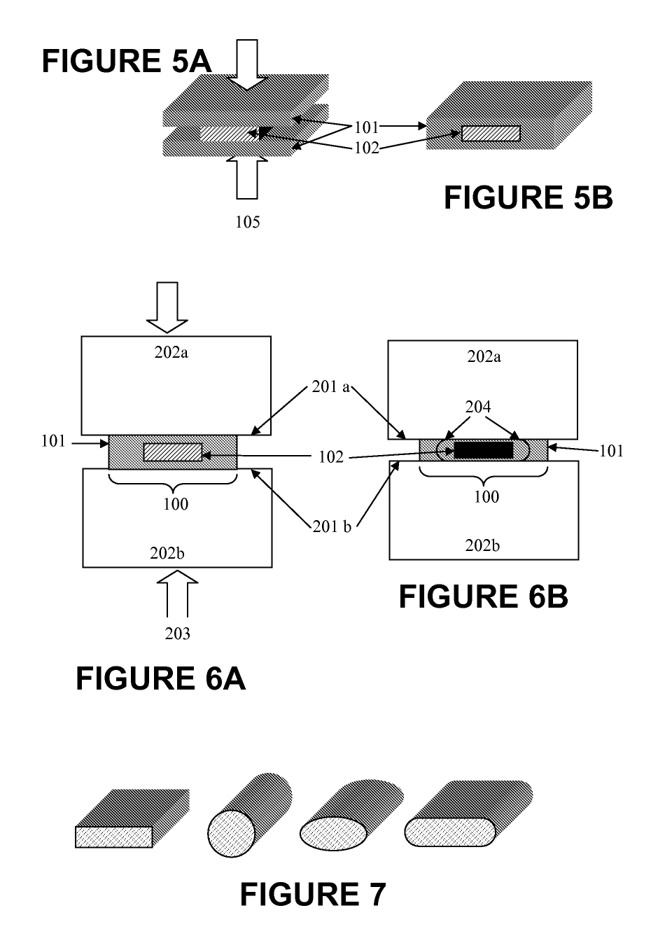

FIGS. 5A and 5B illustrate the preform 100 cross-section before (FIG. 5A) and after pressing (FIG. 5B) of the solder 101 and RCM 102 together. The strip of RCM 102 is shown between solder sheets 101 before (FIG. 5A) and after (FIG. 5B) the application of pressure as at 105. During and after pressing, the upper and lower solder sheets 101A and 101B deform around the RCM 102 and can no longer be individually distinguished.

A seal of the present disclosure is formed as shown in FIG. 6A, with the pressed preform 100, comprising solder 101 and the embedded RCM strip 102 placed between the surfaces 201a and 201b of the two bodies 202a and 202b to be sealed together, e.g. the lid and the wall of a container. Pressure, as indicated by 203, is subsequently applied to hold the two surfaces 201a and 201b against the preform 100 while the RCM 102 is ignited, such as at the extending tab 104. The RCM 102 reacts, generating heat sufficient to melt the solder 101 completely above and below the RCM 102. The solder 101 laterally adjacent to the RCM 102 also melts for some distance from the RCM 102. This distance may vary depending on the composition of the solder 101 and RCM 102, as well as the relative dimensions thereof, but is typically on the order of 150 micrometers. This molten solder 101 adheres to the two sealing surfaces 201a and 201b, fusing them together as the molten solder cools. The molten solder also flows together around the ignited RCM 201, creating a continuous layer of solder between the two sealing surfaces 201a and 201b.

FIG. 6B shows a cross-section of the resulting seal after the RCM reaction has completed and the solder 101 has melted within the region marked by curved lines 204, adhering to surfaces 201a and 201b. The two bodies 202a and 202b are shown slightly closer together than they were prior to sealing, due to shrinkage of the RCM and to a flow of the molten solder within the sealing region.

It will be recognized that the sealing process of the present disclosure may be utilized with a wide variety of materials and to seal a wide variety of surfaces together. As an example, a Pd—Al reactive multilayer foil 35 μm thick and 0.5 mm wide was folded into a 1 inch by 1 inch square shape as shown in FIGS. 4A-5B. This shape was cold-pressed between two tin-silver-copper (SAC305) solder sheets 25 μm thick to form a sealing preform 100 approximately 2.5 mm wide and 70 μm thick. The preform 100 was positioned between two gold-plated (copper-nickel-gold) stainless steel blocks, placed under pressure, and ignited. The resulting seal was found to have a leak rate of 10⁻⁹ atm·cc/s.

In another embodiment, the sealing preform may be used to form a joint that does not seal; that is, which does not serve to isolate a space from the outside environment.

In related embodiments, the RCM 102 which is utilized in combination with the solder 101 may be round or oval in profile, or any convenient shape. It may be a wire or a flattened wire. It may be cut from a sheet or made by any conventional means such as described in U.S. Pat. No. 6,534,194 or in US Patent Application Publication No. 2004-0247931 A1. Some exemplary profiles for the RCM 102 are shown in FIG. 7. Dimensions of the strip or wire are preferably between 30 to 100 μm thick and between 0.25 to 2 mm wide, but are optimally close to 30 μm thick by 0.5 mm wide. The assembled preform 100 may be between 40 to 1000 μm thick but is preferably less than about 100 μm. The width affects ease of handling, since a very narrow preform is fragile and difficult to manipulate. The thickness depends on the energy in the RCM 102 and the amount of energy needed to melt the surrounding solder 101, but a thinner preform results in a thinner bond line between the adjoining surfaces 201a and 201b, which is usually advantageous and less expensive.

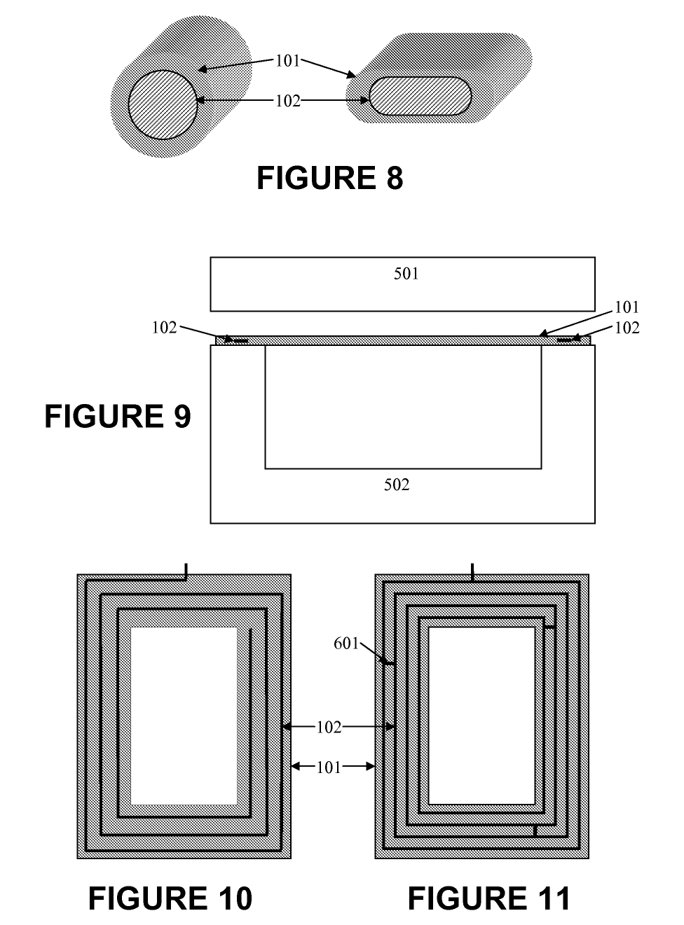

Alternate configurations of the preform 100 may be utilized. For example, as shown in FIG. 8, the solder 101 may be directly wrapped or formed around the RCM strip or wire 102 rather than comprising two separate sheets. The window frame may be formed by any convenient method or, as shown in FIG. 9, the solder 101 may extend beyond the sealing surfaces, covering or partially covering the mouth of the container 502. The RCM strip 102 may be circumferentially looped multiple times as a continuous path within the preform 100 as shown in FIG. 10, or the preform 100 may include multiple interconnected strips of RCM 102 as shown at FIG. 11. In these figures, one solder sheet 101 is shown below the RCM strip(s) 102. If multiple strips of RCM 102 are used in one preform, as shown in FIG. 11, a means of igniting all the strips is needed. One method of igniting all the strips uses small bridging strips of RCM 601, which pass between different sealing strips 102 to allow one sealing strip to ignite the next. Preferably, these bridge strips 601 are spaced apart, for example as shown in FIG. 11, to reduce the chance of a crack or gap forming in the solder around them and extending across the sealing area.

Those of ordinary skill will recognize that during the sealing procedure, the reactive composite material 102 may by ignited by any suitable means, and is not limited to direct ignition at a single point. For example, the exothermic reaction within the RCM 102 may be initiated by induction heating. For procedures in which induction heating is used, individual strips of the RCM 102 need not be touching as in FIG. 11, because the individual strips need not ignite each other. This may make assembly easier because straight disconnected strips may be used, rather than overlapping strips at corners or strips cut to shape.

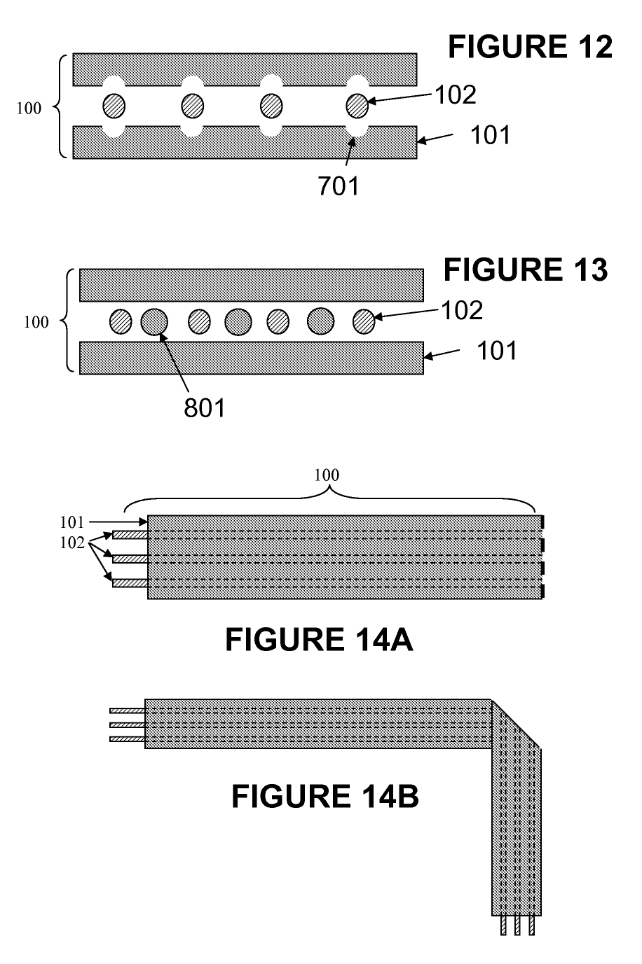

As shown in FIG. 12, which illustrates a cross-sectional view of preform 100, if multiple strips or multiple loops are used, grooves 701 may optionally formed in the solder 101 to accommodate the strips or wires 102 during the pressing phase. To better surround multiple strips with solder, solder wires or strips 801 may additionally be interspersed with the RCM strips 102, as shown in FIG. 13 between the solder layers 101a and 101b. These filler wires or strips 801 may serve several purposes. They may make it easier to seal the solder around the RCM during pressing since the solder sheets 101 would not have to deform as much, thus maintaining flatness as well as providing for better thermal contact between the sides of the RCM 102 and the solder 101 during the reaction.

Alternatively, the wires or strips 801 may comprise a material other than solder, wherein they may provide additional thermal conduction or strength or otherwise modify the material properties of the resulting preform 100 and final seal or bond.

In yet another embodiment, FIG. 14A shows an optional way to incorporate multiple strips of RCM 102 in a continuous ribbon preform that can then be cut to length and folded to shape. Strips of RCM 102 are laid out in parallel between wider strips of solder 101. The assembly is rolled or pressed in a continuous fashion to make a continuous ribbon preform 100. FIG. 14B shows an example of how this continuous ribbon may be folded to form part of a window frame shape. Dimensions are preferably between 5 mm to 100 mm wide, but would typically be less than 10 mm wide. The ribbon could be manufactured very wide then slit to the desired width before use.

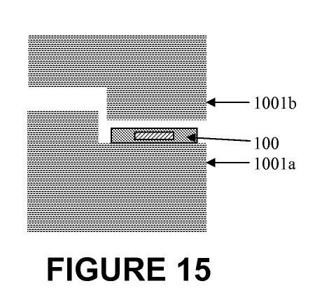

Since the sealed region formed by the methods of the present invention is generally not very wide (typically less than a few millimeters), it may be desirable to design the container 502 and lid 501 to reduce stresses on the sealed region. FIG. 15 shows one possible container 1001a and lid 1001b design that reduces shear stress on the sealed region during service.

Material properties of the solder 101 and the RCM 102 utilized in the preform assembly 100 may be selected for a particular application. For example, higher melting point brazes may be used instead of the solder 101 if the RCM 102 has enough stored energy to be released during an exothermic reaction to melt the braze. On the other hand, a very ductile, low-melting solder 101, such as pure indium, which melts at 157° C. and has a tensile strength of about 4 MPa, may be desirable to provide a compliant seal. The chemistry of the RCM 102 and the layer or reactant region spacing within the RCM 102 may be selected to control the amount of heat produced, the rate at which it is produced, and the maximum temperature reached during the reaction. These variables control how much solder 101 melts, how much the solder 101 is superheated, and whether the reaction is self-propagating or is quenched instead of reacting completely. The effects of chemistry, microstructure, and thermal properties of the RCM 102 and the thermal properties of the materials surrounding the RCM 102 have been discussed in above-referenced published patent applications.

Process control parameters for the sealing process include the RCM reaction properties, cross-section shape, and strip spacing, as well as solder properties and thickness. The thermal properties and surface condition of the two surfaces to be sealed are also important parameters. The surface condition of the sealing surfaces should be smooth and clean. Gold plating is often necessary to ensure good adhesion of the solder within the molten time period. As an alternative to gold plating on the sealing surfaces, the surfaces may be plated with tin or lead-tin alloy to a thickness that may be at least 0.0001″ (2.5 micrometers) up to 0.001″ (25 micrometers) or more.

As an example, an RCM-solder composite ribbon according to the present disclosure was made by cold pressing three RCM strips 102 between sheets of solder 101. The RCM used was a cold-rolled aluminum-palladium composite with stoichiometry 1:1, 0.5 mm wide, 35 μm thick, and 8.7 passes (a measure of amount of deformation and microstructural refinement). The sheet solder was SAC305, 0.003″ (152 μm) thick. The RCM strips were spaced 0.048″ (1.2 mm) apart. A pressure of 72,000 psi (500 MPa) was applied for 5 minutes to form a well-bonded preform.

The following table lists several seals made with different materials and solders in various sizes.

| | | Size, | Leak rate, |
|---|---|---|---|
| Material | Solder | inches | atm · cc/s |
| Au-coated brass | 25 μm SAC305 | 0.5 × 0.5 | <10⁻⁸ |
| Au-coated stainless steel | 25 μm SAC305 | 0.5 × 0.5 | <10⁻⁸ |
| Au-coated stainless steel | 25 μm SAC305 | 1 × 1 | <10⁻⁸ |
| Au-coated stainless steel | 25 μm Sn 3.5 Ag | 0.5 × 0.5 | <10⁻⁸ |
| Au-coated aluminum | 25 μm SAC305 | 0.5 × 0.5 | <10⁻⁸ |
| Au-coated aluminum | 25 μm Sn 3.5 Ag | 0.5 × 0.5 | <10⁻⁸ |
| Pre-wet (100 μm) Au-coated | 25 μm SAC305 | 1 × 1 | <10⁻⁸ |
| stainless steel | | | |

The RCM used was a cold-rolled aluminum-palladium composite with stoichiometry 1:1. For the brass and stainless steel samples, the RCM was 0.5 mm wide, 35 μm thick, and 8.7 passes (a measure of amount of deformation and microstructural refinement). The RCM strip was bent into a square shape and then cold pressed between two sheets of SAC305 solder each 0.001″ (25 μm) thick. After pressing, excess solder was cut away to form a window frame shape with 0.1″ (2.5 mm) wide walls, similar to FIG. 4A. The window frame was positioned between two blocks of material (gold-coated brass or gold-coated stainless steel), a load was applied, and the end of the RCM that extended out of the bond was ignited to form the seal. The leak rate was tested using a helium leak detector attached to a hole in one of the two blocks. Both configurations produced leak rates lower than 10⁻⁸ atm·cc/s.

In one embodiment, the present disclosure provides a seal comprising at least two components with adjacent surfaces, defining an inside and an outside of a container; at least one strip of reacted RCM between the adjacent surfaces of the two components; and a fusible material substantially surrounding the at least one strip of reacted RCM, adhered to the at least one strip of reacted RCM and the adjacent surfaces of the at least two components. The resulting seal has an helium leak rate across the joint is less than 10⁻⁸ atm·cc/s.

In a second embodiment, the present disclosure provides a sealed container with a seal formed by at least one strip of reacted RCM between adjacent container surfaces; and a fusible material substantially surrounding the at least one strip of reacted RCM, adhered to the at least one strip of reacted RCM and the adjacent surfaces of the container.

In a third embodiment, the present disclosure provides an object sealed within a container with a seal formed by at least one strip of reacted RCM between adjacent container surfaces; and a fusible material substantially surrounding the at least one strip of reacted RCM, adhered to the at least one strip of reacted RCM and the adjacent surfaces of the container.

In one method, the present invention provides a process for joining two surfaces comprising providing, between the two surfaces, a thin strip or wire of RCM fully surrounded with a fusible material; applying pressure; and igniting the RCM to melt at least some of the fusible material, wherein the fusible material adheres to the two surfaces, joining them.

In a second method, the present invention provides a method for fusing a connection between two surfaces by providing, between the two surfaces, a thin strip or wire of RCM fully surrounded with a fusible material; applying pressure; and igniting the RCM to melt at least some of the fusible material, wherein the fusible material adheres to the two surfaces, joining them.

The present disclosure further provides a joint bonding two components with adjacent surfaces, comprising at least one strip of reacted RCM between the adjacent surfaces of the two components; and a fusible material substantially surrounding the at least one strip of reacted RCM, adhered to the at least one strip of reacted RCM and the adjacent surfaces of the at least two components.

As a method for sealing a container, the present disclosure comprises the steps of providing at least two components of the container, defining an inside and an outside of the container; providing between the two components at least one thin strip or wire of RCM surrounded with a fusible material; and chemically transforming the at least one strip or wire of RCM so as to melt at least a portion of the fusible material so as to join the at least two components. The present disclosure further encompasses the resulting sealed container, and a resulting sealed container containing an object within a hermetically sealed environment.

For use in sealing or joining adjacent surfaces, the present disclosure provides a preform consisting of one or more strips of RCM surrounded by fusible material, wherein the strip is bent or folded so as to lie continuously along a surface to be joined. The preform may have a long dimension cross-section of the strip of RCM between 0.25 and 2 mm wide, and a short dimension of the cross-section of the strip of RCM between 30 μm and 100 μm wide. The fusible material may optionally contain at least one groove to accommodate the strips of RCM, and strips of the fusible material may be interspersed with the strips of RCM. Alternatively, strips of another metal may optionally be interspersed with the strips of RCM. The overall width of the preform may be within a range between 0.5 and 100 mm, but is preferably within a range of between 0.5 and 6 mm. The overall thickness of the preform is may be within a range between 40 μm and 1000 μm.

The present disclosure further provides for seals made using the sealing preform, containers sealed with the sealing preform, and containers holding objects within a hermetically sealed environment sealed by the sealing preform.

As various changes could be made in the above constructions without departing from the scope of the disclosure, it is intended that all matter contained in the above description or shown in the accompanying drawings shall be interpreted as illustrative and not in a limiting sense.

1. A seal between at least two components having adjacent surfaces, comprising:
at least one strip of reacted RCM disposed between the adjacent surfaces of the two components; and
a fusible material substantially surrounding the at least one strip of reacted RCM, said fusible material adhered to the at least one strip of reacted RCM and to each of the adjacent surfaces of the at least two components.

2. The seal of claim 1 wherein the helium leak rate between the adjacent surfaces is less than 10⁻⁸ atm·cc/s.

3. A container defining an enclosed volume between a component body and a component lid, said component lid sealed to said component body at adjacent surfaces with the seal of claim 1.

4. A container of claim 3 containing an object within said enclosed volume.

5. A method of joining adjacent surfaces comprising:
providing between the adjacent surfaces, a strip or wire of RCM enclosed within a fusible material;
applying pressure to urge the adjacent surfaces toward each other; and igniting the RCM to melt at least some of the fusible material, wherein the melted fusible material adheres continuously to the adjacent surfaces upon cooling, forming a continuous bond there between.

6. A bond between adjacent surfaces formed by the method of claim 5.

7. A bonded joint between at least two components having adjacent surfaces, comprising:
at least one strip of reacted RCM disposed between the adjacent surfaces of the two components; and
a fusible material substantially surrounding the at least one strip of reacted RCM, said fusible material adhered continuously to the at least one strip of reacted RCM and each of the adjacent surfaces of the at least two components.

8. A method of sealing a container defining an enclosed volume between adjacent surfaces of a component body and a component lid, comprising:
providing between the component body and the component lid, at least one segment of RCM embedded within a fusible material; and
chemically transforming the at least one segment of RCM so as to melt at least a portion of the embedding fusible material to form a continuous bond about at least the peripheral edge of the adjacent surfaces between the component body and the component lid.

9. A container sealed by the method of claim 8.

10. A container of claim 9 containing an object within the enclosed volume.

11. A sealing preform comprising at least one segment of RCM embedded within a fusible material.

12. The sealing preform of claim 11 wherein the long dimension of the cross-section of the segment of RCM is between 0.25 mm and 2 mm wide.

13. The sealing preform of claim 11 wherein the short dimension of the cross-section of the segment of RCM is between 30 μm and 100 μm wide.

14. The sealing preform of claim 11 wherein said segment of RCM is disposed within an internal groove within said embedding fusible material.

15. The sealing preform of claim 11 further comprising at least a second segment of RCM embedded within said fusible material.

16. The sealing preform of claim 15 further comprising at least one segment of fusible material interspersed between said segments of RCM.

17. The sealing preform of claim 15 further comprising at least one metallic segment interspersed between said segments of RCM.

18. The sealing preform of claim 11 wherein a width of the preform is within a range between 0.5 mm and 100 mm.

19. The sealing preform of claim 18 wherein a width of the preform is within a range between 0.5 mm and 6 mm.

20. The sealing preform of claim 11 wherein a thickness of the preform is within a range between 40 μm and 1000 μm.

21. A seal between adjacent surfaces of a plurality of components, said seal formed with a sealing preform of claim 11.

22. A container defining an enclosed volume between a body and a lid, said lid sealed to said body with a sealing preform of claim 11.

23. A container of claim 22 containing an object within said enclosed volume.
